(19) United States
(12) Patent Application Publication
(10) Pub. No.: US 2026/0301365 A1
(43) Pub. Date: Oct. 1, 2026

(54) METHOD AND SYSTEM FOR DETERMINING SIMILARITY BETWEEN IMAGES USING PAIR-WISE DIVERGENCE MATRIX

(71) Applicant: HCL Technologies Limited, New Delhi (IN)

(72) Inventors: Mallamgari Nithin Reddy, Bengaluru (IN); Vedasamhitha Challapalli, Bengaluru (IN); Rupesh Prasad, Bengaluru (IN); Atul Singh, Bengaluru (IN); Arvind Maurya, Noida (IN)

(21) Appl. No.: 19/440,737

(22) Filed: Jan. 6, 2026

(30) Foreign Application Priority Data
Mar. 27, 2025 (IN) 202511029031

(51) Int. Cl. G06V 10/74; G06V 10/70; G06V 10/776

(52) U.S. Cl. CPC G06V 10/761; G06V 10/87; G06V 10/776

(57) ABSTRACT

A method and a system for determining similarity between images, using a pair-wise divergence matrix, is disclosed. The method includes computing, by a processor, a pair-wise divergence value of each patch of a first image relative to each patch of the second image using an F-divergence method. The pair-wise divergence value is computed using a probability distribution of each patch of the first image relative to each patch of the second image. The method further includes creating, by the processor, a pair-wise divergence matrix based on the computed pair-wise divergence values of each patch of the first image relative to each patch of the second image. The method further includes calculating, by the processor, a similarity score between the first image and the second image based on the pair-wise divergence matrix.

### TECHNICAL FIELD

This disclosure generally relates to determining similarity between images and, more particularly, to a method and system for determining similarity between images using a pair-wise divergence matrix.

### BACKGROUND

Determining similarity between images is essential, such as verifying uniqueness, evaluating image data for plagiarism, and identifying similar visual content. Evaluating image similarity extends beyond identifying duplicates by evaluating the semantic and visual closeness between images, such as checking similarity helps in search algorithms to find similar content from a large dataset. In addition, current existing solutions for measuring similarity often depend on vectors and angular measurements between datasets, pixel-based similarity determination, and the like.

Although these techniques are effective in straightforward scenarios, these existing techniques are vulnerable to disruptions like unnecessary elements, characters, emojis, or slight alterations in images or pixels, which can greatly affect the vector-based method and result in inaccurate outcomes.

Therefore, an optimal methodology is required to measure the similarity between images with high accuracy.

### SUMMARY OF THE INVENTION

In an embodiment, a method for determining the similarity between images using a pair-wise divergence matrix is disclosed. The method may include computing, by a processor, a pair-wise divergence value of each patch of a first image relative to each patch of a second image using an F-divergence method selected from a plurality of F-divergence methods. It should be noted that the pair-wise divergence value is computed using a probability distribution of each patch of the first image relative to each patch of the second image. The method may further include creating by the processor, a pair-wise divergence matrix based on the computed pair-wise divergence values of each patch of the first image relative to each patch of the second image. The method may further include calculating, by the processor, a similarity score between the first image and the second image based on the pair-wise divergence matrix.

In another embodiment, a system for determining the similarity between images using a pair-wise divergence matrix is disclosed. The system may include a processor, and a memory communicably coupled to the processor, wherein the memory stores processor-executable instructions, which when executed by the processor, cause the processor to compute a pair-wise divergence value of each patch of a first image relative to each patch of a second image using an F-divergence method selected from a plurality of F-divergence methods. It should be noted that the pair-wise divergence value is computed using a probability distribution of each patch of the first image relative to each patch of the second image. The processor may be further configured to create a pair-wise divergence matrix based on the computed pair-wise divergence values of each patch of the first image relative to each patch of the second image. The processor may be further configured to calculate a similarity score between the first image and the second image based on the pair-wise divergence matrix.

It is to be understood that the foregoing general description and the following detailed description are exemplary and explanatory only and are not restrictive of the invention, as claimed.

### BRIEF DESCRIPTION OF DRAWINGS

The accompanying drawings, which are incorporated in and constitute a part of this disclosure, illustrate exemplary embodiments and, together with the description, serve to explain the disclosed principles.

FIG. 1 illustrates a functional block diagram of an exemplary system for determining similarity between images using a pair-wise divergence matrix, in accordance with an embodiment of the present disclosure.

FIG. 2 illustrates a functional block diagram of various modules within a memory of a computing device, configured to determine similarity between images using a pair-wise divergence matrix, in accordance with an exemplary embodiment of the present disclosure.

FIG. 3 illustrates two images that are divided into patches in order to perform similarity determination, in accordance with an embodiment of the present disclosure.

FIGS. 4A-4B illustrate a pair-wise divergence matrix created for two images, in accordance with an exemplary embodiment of the present disclosure.

FIG. 5 illustrates a flowchart of a method for determining similarity between images using a pair-wise divergence matrix, in accordance with an exemplary embodiment of the present disclosure.

FIG. 6 illustrates another flowchart of a method for determining similarity between images using a pair-wise divergence matrix, in accordance with an exemplary embodiment of the present disclosure.

FIG. 7 illustrates a flowchart of a method for calculating similarity score, in accordance with an exemplary embodiment of the present disclosure.

FIG. 8 illustrates a flow diagram of a method for selecting an F-divergence method from the plurality of the F-divergence methods, in accordance with an exemplary embodiment of the present disclosure.

### DETAILED DESCRIPTION OF THE DRAWINGS

Exemplary embodiments are described with reference to the accompanying drawings. Whenever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered exemplary only, with the true scope being indicated by the following claims. Additional illustrative embodiments are listed below.

Further, the phrases “in some embodiments”, “in accordance with some embodiments”, “in the embodiments shown”, “in other embodiments”, and the like, mean a particular feature, structure, or characteristic following the phrase is included in at least one embodiment of the present disclosure and may be included in more than one embodiment. In addition, such phrases do not necessarily refer to the same embodiments or different embodiments. It is intended that the following detailed description be considered exemplary only, with the true scope and spirit being indicated by the following claims.

Typically, the method used for similarity determination between images, such as cosine similarity, is based on vector spaces and angular distances between patches embeddings. Although these approaches work well for simple cases, they are sensitive to noise like unnecessary characters, pictures, or slight changes in the lexicon that can change patch embedding significantly. This constraint is especially evident in high-dimensional embedding spaces because a single change can alter multiple dimensions. Accordingly, the present disclosure provides a method and system for determining the similarity between images using a pair-wise divergence matrix.

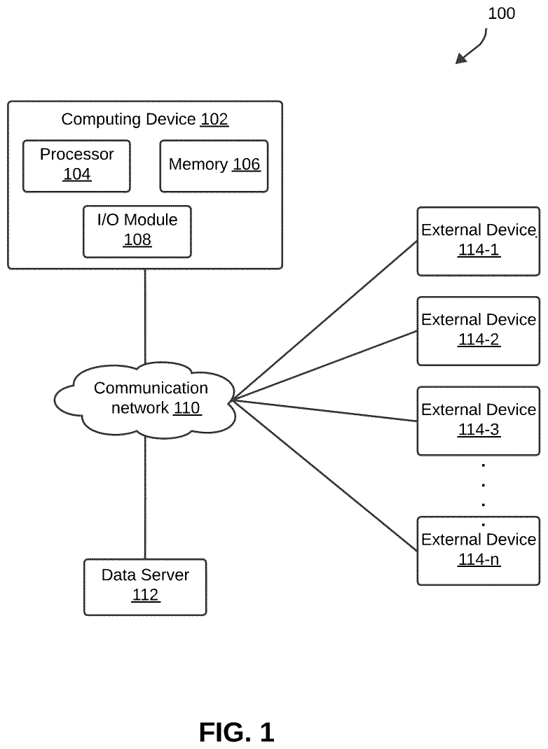

Referring now to FIG. 1, a functional block diagram 100 of an exemplary system for determining similarity between images using a pair-wise divergence matrix is illustrated, in accordance with an embodiment of the present disclosure. The system 100 may include a computing device 102 that may be configured to determine similarity between images using a pair-wise divergence matrix. The computing device 102 may be configured to perform a plurality of functions such as receiving input from a user and processing the received input in order to provide expected output. The computing device 102, for example, may be one of, but is not limited to a smartphone, a laptop computer, a desktop computer, a notebook, a workstation, a server, a portable computer, a handheld, or a mobile device. The computing device 102 may include a processor 104, and a memory 106. Examples of processor 104 may include but are not limited to, an Intel® Itanium® or Itanium 2 processor, AMD® Opteron® or Athlon MP® processor, Motorola® lines of processors, Nvidia®, FortiSOC™ system on a chip processor, or other future processors.

Further, the memory 106 may store instructions that, when executed by the processor 104, cause the processor 104 to implement various functionalities such as determining the similarity between one or more images using a pair-wise divergence matrix, as will be discussed in greater detail below. In an embodiment, the memory 106 may be a non-volatile memory or a volatile memory. Examples of non-volatile memory may include but are not limited to flash memory, Read Only Memory (ROM), Programmable ROM (PROM), Erasable PROM (EPROM), and Electrically EPROM (EEPROM) memory. Further, examples of volatile memory may include but are not limited to Dynamic Random Access Memory (DRAM), and Static Random-Access Memory (SRAM).

The computing device 102 may also include an I/O (Input/Output) module 108. The I/O module 108 may include a variety of interface(s), for example, interfaces for data input and output devices, and the like. In an embodiment, the I/O module 108 may be connected to a communication pathway for one or more components of the computing device 102 to facilitate the transmission of inputted instructions and output results of data generated by various components such as, but not limited to, the processor 104 and the memory 106.

The computing device 102 may be communicatively coupled to the data server 112 and a plurality of external devices 114a-114n through a communication network 110. The external devices 114a-114n, for example, may be, but are not limited to a smartphone, a laptop computer, a desktop computer, a notebook, a workstation, a server, a portable computer, a handheld, or a mobile device. The communication network 110 may be a wired or a wireless network or a combination thereof. The communication network 110 can be implemented as one of the different types of networks, such as but not limited to, ethernet IP network, intranet, local area network (LAN), wide area network (WAN), the internet, Wi-Fi, Long Term Evolution (LTE) network, Code Division Multiple Access (CDMA) network, 5G and the like. Further, the communication network 110 may either be a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further, the communication network 110 may include a variety of network devices, including routers, bridges, servers, computing devices, storage devices, and the like.

In an embodiment, the data server 112 may be enabled in a remote cloud server or a co-located server and may include a database to store an application and other data necessary for the system 100 to perform similarity determination between images. In an embodiment, the data server 112 may store data input by an external device 114a-114n (for example, documents or images) or output generated by the computing device 102 (for example, similarity index with respect to document/images). It is to be noted that the application may be designed and implemented as either a web application or a software application. The web application may be developed using a variety of technologies such as Hyper Text Markup Language (HTML), Cascading Stylesheet (CSS), JavaScript, and various web frameworks like React, Angular, or Vue.js. It may be hosted on a web server and accessible through standard web browsers. On the other hand, the software application may be a standalone program installed on users' devices, which may be developed using programming languages such as Java, C++, Python, or any other suitable language depending on the platform. In an embodiment, the computing device 102 may be communicably coupled with the data server 112 through the communication network 110.

In some embodiments, the computing device 102 may receive a user input for determining similarity between images using a pair-wise divergence matrix, from one or more external devices 114a-114n through the communication network 110. The computing device 102 may use a pair-wise divergence matrix to determine similarity between the images. The computing device 102 may perform various functions in order to determine a similarity between the images using the pair-wise divergence matrix. By way of an example, the computing device 102 may receive two or more images as an input either from the I/O module 108 or from one of the external devices 114-a to 114-n in order to perform a determination of similarity between the received images. For example, the user may insert the images using a user input interface or indicate a file path for the images via the I/O module 108. In an embodiment, the similarity determination function or application may undergo similarity determination testing to ensure its performance under various conditions. One example of at least one testing scenario may include performing similarity determination between images having extra and unnecessary symbols, characters, and/or similar objects included in the images to ensure the semantic meaning is also being compared in order to check the similarity between two images, as will be discussed in greater detail herein below.

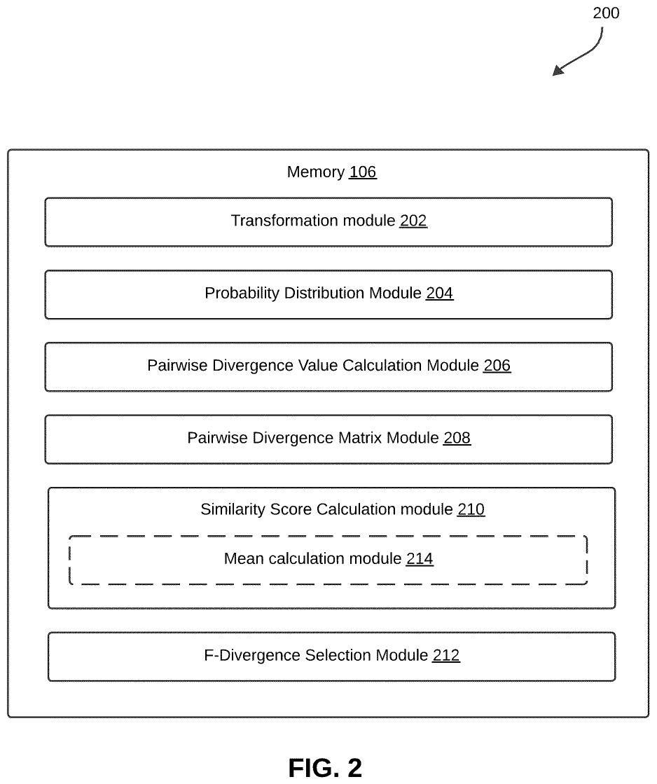

Referring now to FIG. 2, a functional block diagram 200 of various modules within a memory 106 of a computing device configured to determine similarity between images using a pair-wise divergence matrix is illustrated, in accordance with an exemplary embodiment of the present disclosure. In an embodiment, the memory 106 may include a transformation module 202, a probability distribution module 204, a pair-wise divergence value calculation module 206, a pair-wise divergence matrix module 208, a similarity score calculation module 210, and an F-divergence Selection module 212. The similarity score calculation module 210 may further include a mean calculation module 214.

In an embodiment, a first image and a second image may be received by the computing device 102 for computation of similarity between these images. It will be apparent that two images are considered for convenience of explanation, however, the similarity may be determined between multiple images or specific portions of given images.

Once the first image and the second image are received, the transformation module 202 may transform a plurality of patches in each of the received first image and the second image into patch embeddings. The patches may be described as the small group or area of pixels in the image, also referred to as sliding window. The patches are powerful primitives in the area of image processing such as similarity determination between two images. Patch embeddings for an image are a way to represent the patches as numbers so that the computing device 102 may understand and perform further processing. It should be noted that the patches with similar objectives and similar contexts are represented by similar vectors. The patches may be represented as vectors in a multi-dimensional space. The transformation from patches of the images to vectors may be done by using the existing algorithms, such as, but not limited to the Vision Transformer (ViT) model, image embedding model, or a multimodal embedding model supported by Vertex AI. By analysing an image, a model generates image embedding that encodes each visual element of the image (shape, color, pattern, texture, action, or object) as a vector representation. For example, to convert image patches into embeddings, the most common method is to use a “patch embedding” layer within a ViT model, dividing the first image into smaller patches, then flattening each patch into a vector, and finally applying a linear projection to transform those vectors into the desired embedding dimension, essentially creating a sequence of patch embeddings ready for processing by the transformer layers.

The probability distribution module 204 may normalize each of the plurality of patch embeddings into the associated probability distributions. The probability distribution module 204 may use a predefined function to normalize the patch embedding into a plurality of probability distributions. The predefined function, for example, maybe but is not limited to the Softmax function, Euclidean Norm, and the like. The Softmax function converts a vector of raw scores into probabilities by taking an exponential of each score and normalizing them so that the sum of each score equals 1.

For example, for an exemplary vector z=[z1, z2, z3, . . . , zn], the Softmax function computes the probability distribution using the equation 1 given below:

$$σ ( {z}_{i} ) = \frac{{e}^{z} i}{{\sum }_{j = 1}^{n} {e}^{{z}_{j}}} \qquad ( 1 )$$

Once the probability distribution for each of the plurality of patch embeddings is determined, the pair-wise divergence value calculation module 206 may compute a pair-wise divergence value of each patch of the first image relative to each patch of the second image using an F-divergence method. The F-divergence method may be selected from a plurality of F-divergence methods. The divergence measure (or similarity) and associated properties depend on the choice of the F-divergence method that is selected. It should be noted that the pair-wise divergence value is computed using the probability distribution of each patch of the first image relative to each patch of the second image. In other patches, the pair-wise divergence values may be calculated for all patch-pair embeddings of the first image and the second image.

F-divergence methods (also known as Csiszar-Morimoto divergence) are a broader framework in terms of measuring the difference between two probability distributions. Examples of F-divergence methods may include but are not limited to Kullback-Leibler (KL) divergence, Jenson-Shannon (JS) divergence, Total Variation distance, Hellinger distance, and the like.

In some embodiments, F-divergence may be defined using the equation 2 given below:

$${D}_{f} ( P ‖ Q ) ≡ {\int }_{Ω} f ( \frac{d P}{d Q} ) d Q \qquad ( 2 )$$

The JS divergence is a specific type of F-divergence and derived from the F-divergence method and is derived from F-divergence by selecting the function defined in equation 3 given below:

$$f ( t ) = \frac{1}{2} ( tlnt - ( t + 1 ) ln ( \frac{t + 1}{2} ) ) \qquad ( 3 )$$

The F-divergence Selection Module 212 identifies the optimal F-divergence method from the plurality of F-divergence methods and selects the optimal F-divergence method based on a comparison of the calculated similarity score using an F-divergence method and human judgment data. The F-divergence Selection Module 212 may include iteratively performing the pair-wise divergence calculation on a plurality of F-divergence methods based on the pair-wise divergence matrix in order to select the optimal F-divergence method for a particular pair of images based on comparison with human judgment data.

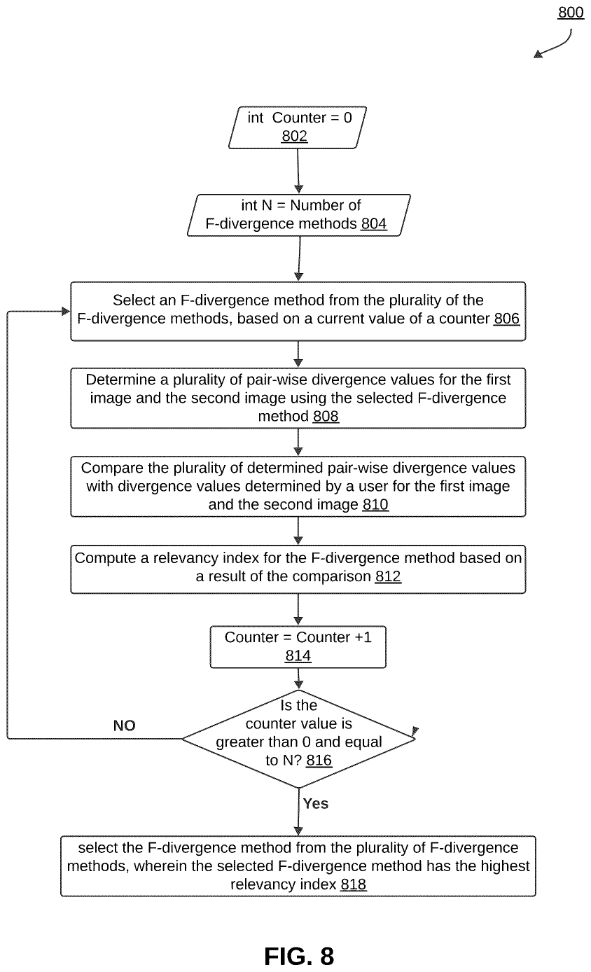

The F-divergence Selection Module 212 may identify the optimal F-divergence method from the plurality of F-divergence methods for the first image and the second image, based on a comparison between similarity scores computed using each of the plurality of F-divergence methods and human judgment data. The F-divergence selection module 212 computes a relevancy index for each of the plurality of F-divergence methods based on a result of the comparison. In conclusion, the F-divergence selection module 212 selects the F-divergence method from the plurality of F-divergence methods that have the highest computed relevancy index. This is further explained in detail in conjunction with the flowchart given in FIG. 8.

The similarity or divergence measure and the properties depend on the choice of the F-divergence. The F-divergences are more frequently employed in information theory, machine learning, and statistics for various purposes including hypothesis testing and variational inference. The F-divergence selection module 212 may identify the optimal F-divergence method from the plurality of F-divergence methods for the first image and the second image, based on a comparison between similarity scores computed using each of the plurality of F-divergence methods and human judgment data. The F-divergence selection module 212 computes a relevancy index for each of the plurality of F-divergence methods based on a result of the comparison. In conclusion, the F-divergence selection module 212 selects the F-divergence method from the plurality of F-divergence methods that have the highest computed relevancy index. This is further explained in detail in conjunction with the flowchart given in FIG. 8.

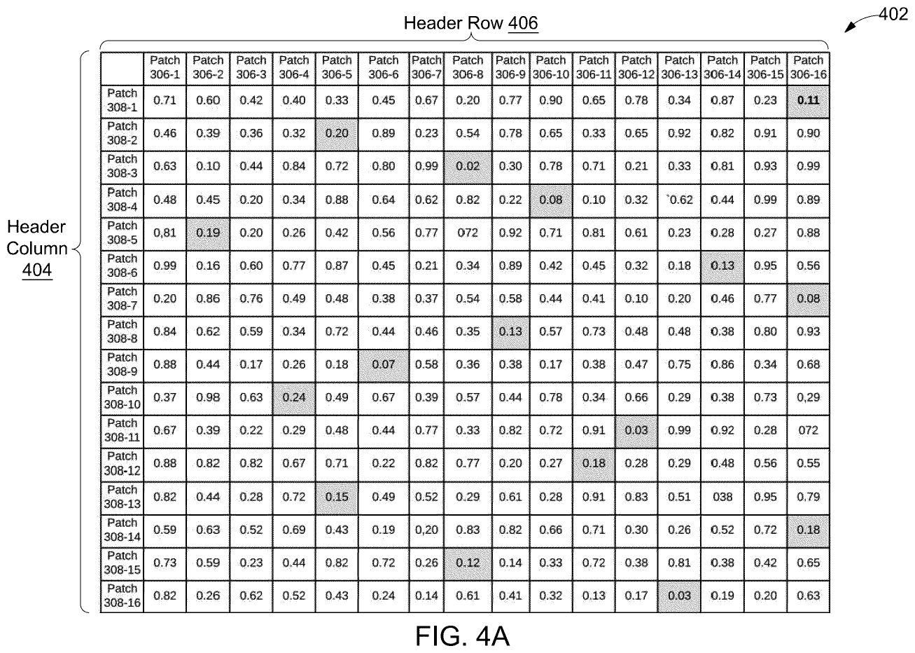

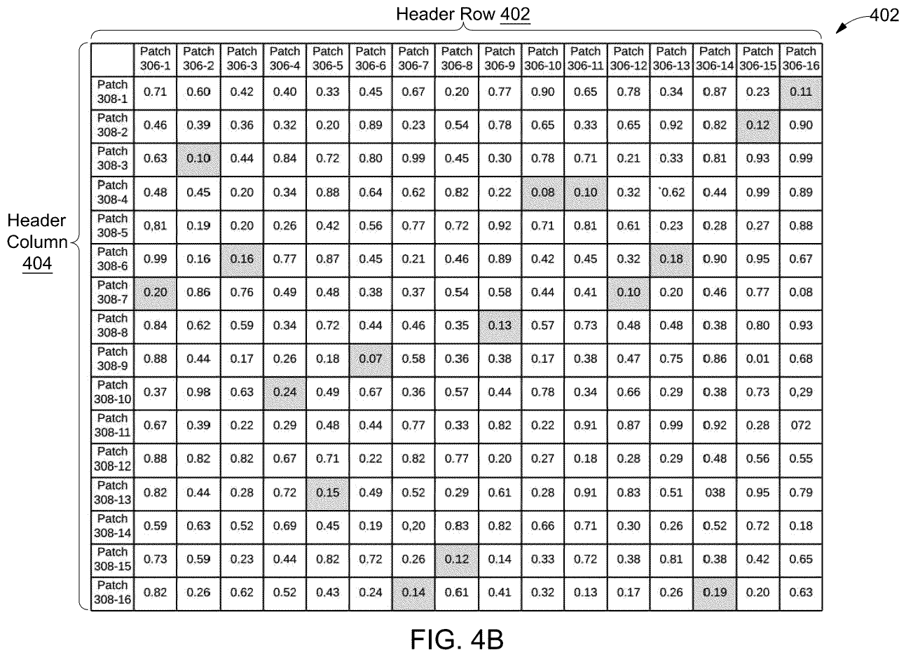

The pair-wise divergence matrix module 208, may create a pair-wise divergence matrix based on the computed pair-wise divergence values of each patch of the first image relative to each of the patches of the second image. It should be noted that the pair-wise divergence matrix is a two-dimensional matrix. The pair-wise divergence matrix includes a header column that includes each of the patches of the first image in a unique cell, and a header row includes each of the patches of the second image in a unique cell. The pair-wise divergence matrix module 208 may further include listing the computed pair-wise divergence value of each patch of the first image relative to each patch of the second image in an intersecting cell of the pair-wise divergence matrix. It should be noted that the intersecting cell is an intersection between a row associated with a first patch of the header column and a column associated with a second patch of the header row. This is further explained in detail in conjunction with FIG. 4A.

Thereafter, the similarity score calculation module 210 calculates the similarity score between the first image and the second image based on the pair-wise divergence matrix. For a given patch of the first image, the similarity score calculation module may identify a minimum divergence value from the plurality of F-divergence values in the row that corresponds to the given patch in the pair-wise divergence matrix. The similarity score calculation module 210 may further include the mean calculation module 214 that may calculate the weighted mean of the pair-wise divergence values of patches of each of the images as given in the pair-wise divergence matrix.

For each patch of the first image, the mean calculation module 214 may identify a minimum divergence value from the plurality of F-divergence values in the corresponding row of the pair-wise divergence matrix. The mean calculation module 214 may determine a first weighted divergence value based on multiplication of the identified minimum divergence value with an associated weight, for each patch of the first image. The mean calculation module 214 may calculate a first weighted mean based on the first weighted divergence value determined for each patch of the first image. Similarly, for each patch of the second image, the mean calculation module 214 may identify a minimum divergence value from the plurality oF-divergence values in the corresponding column for each patch of the second image in the pair-wise divergence matrix. The mean calculation module 214 may determine a second weighted divergence value based on the multiplication of the identified minimum divergence value with an associated weight, for each patch of the second image. Based on the second weighted divergence value determined for each patch of the second image, the mean calculation module 214 may calculate a second weighted mean.

It should be noted that all such aforementioned modules 202-214 may be represented as a single module or a combination of different modules. Further, as will be appreciated by those skilled in the art, each of the modules 202-214 may reside, in whole or in parts, on one device or multiple devices in communication with each other. In some embodiments, each of the modules 202-214 may be implemented as a dedicated hardware circuit comprising custom application-specific integrated circuits (ASIC) or gate arrays, off-the-shelf semiconductors such as logic chips, transistors, or other discrete components. Each of the modules 202-214 may also be implemented in a programmable hardware device such as a field programmable gate array (FPGA), programmable array logic, programmable logic device, and so forth. Alternatively, each of the modules 202-214 may be implemented in software for execution by various types of processors (e.g., processor 104). An identified module of executable code may, for instance, include one or more physical or logical blocks of computer instructions, which may, for instance, be organized as an object, procedure, function, or other construct. Nevertheless, the executables of an identified module or component need not be physically located together but may include disparate instructions stored in different locations which, when joined logically together, include the module and achieve the stated purpose of the module. Indeed, a module of executable code could be a single instruction, or many instructions, and may even be distributed over several different code segments, among different applications, and across several memory devices.

As will be appreciated by one skilled in the art, a variety of processes may be employed for determining similarity between images using a pair-wise divergence matrix. For example, the exemplary system 100 and the associated processor 104 may determine the similarity between images using a pair-wise divergence matrix, by the processes discussed herein.

In particular, as will be appreciated by those of ordinary skill in the art, control logic and/or automated routines for performing the techniques and steps described herein may be implemented by the system 100 and the associated computing device 102 either by hardware, software, or combinations of hardware and software. For example, suitable code may be accessed and executed by one or more processors on the system 100 to perform some or all of the techniques described herein. Similarly, application-specific integrated circuits (ASICs) configured to perform some, or all of the processes described herein may be included in one or more processors on the system 100.

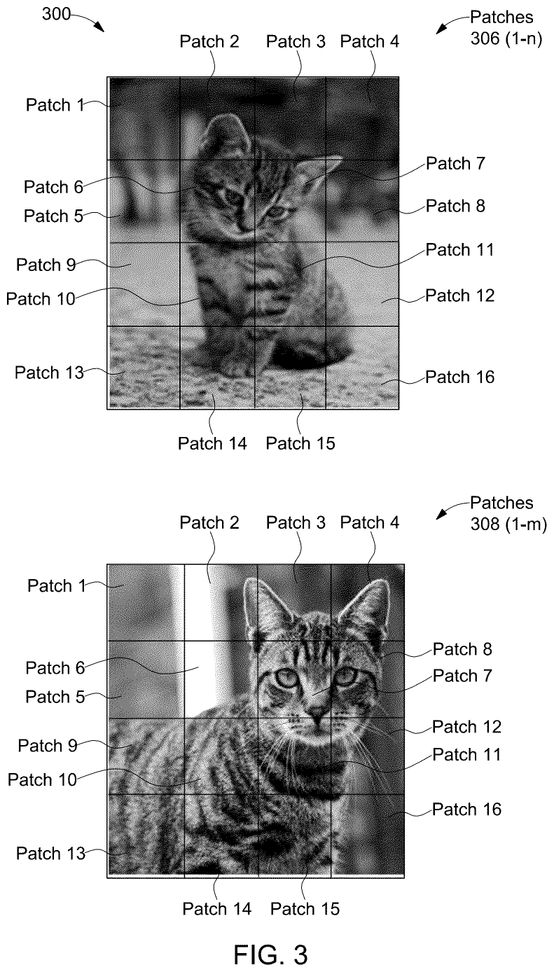

Referring now to FIG. 3, two images divided into patches in order to perform similarity determination are illustrated, in accordance with an embodiment of the present disclosure. The illustration of two images is depicted as a first image 302 and a second image 304 in FIG. 3. The first image 302 is divided into a plurality of patches 306 (1-n). Similarly, the second image 304 is divided into a plurality of patches 308(1-m). A patch may be described as a small group of pixels of an image. The number of pixels in a particular patch may vary according to the needs of the similarity determination. For example, if a user needs to check the similarity between a house image and a dog image, the number of pixels in a patch may be larger, requiring a less detailed comparison than if a user needs to check the similarity between two face images of two humans, requiring detailed comparison between two images. It should be noted that the number of pixels per patch for the first image 302 is identical to the number of pixels per patch for the second image 304. Also, the number of pixels per patch is uniform for the whole image. The first image 302 and the second image 304 may be divided into the plurality of patches 306(1-n) and 308(1-m) using a predefined function such as but not limited to some existing Python libraries, split function, patchify function, and the like.

Further, a weight is assigned to each of the patches 306(1-n) of the first image 302 and each of the patches 308(1-m) of the second image 304. The weighting process may be described as determining a numerical value for each of the patches 306(1-n) and patches 308(1-m) within the first image 302 and the second image 304, representing relative importance often based on a plurality of factors, such as, but not limited to texture, edge information, or similarity to other patches in the first image 302 and the second image 304. The weight assignment techniques may include, but are not limited to using gradient-based methods to identify areas of high image chances such as edges, distance-based weighting techniques include identifying patches that are closer to the center and are given higher weights relative to the patches that are far from the center of an image, saliency map-based weighting, highlighting important regions in the image, feature-based weighting techniques, determining the importance of specific features like texture or color, and the like. Weighting techniques may also use a neural network that is trained to generate weights based on the image content. Utilizing a weighting technique from the plurality of weighting techniques, a plurality of weights is assigned to each of the patches 306(1-n) and 308(1-m) of the first image 302 and the second image 304, further assists in calculating the similarity score between the first image 302 and the second image 304.

Referring now to FIGS. 4A-4B, a pair-wise divergence matrix 402 created for two images is illustrated, in accordance with an exemplary embodiment of the present disclosure, in conjunction with FIG. 3. The pair-wise divergence matrix 402 is created based on the computed plurality of pair-wise divergence values of each of the patches 306(1-n) of the first image 302 relative to each of the patches 308(1-m) of the second image 304. The pair-wise divergence matrix 402 consists of the dimensions n x m. The ‘n’ is the total number of patches 306(1-n) in the first image 302 and the ‘m’ is the total number of patches 308(1-m) in the second image 304. In an embodiment, a header column 404 of the pair-wise divergence matrix 402 includes each patch 306(1-n) of the first image 302 in a unique cell, and a header row 406 of the pair-wise divergence matrix 402 consists of each patch 308(1-m) of the second image 304 in a unique cell. In an embodiment, the pair-wise divergence matrix 402 includes the computed pair-wise divergence value of each patch 306(1-n) of the first image 302 relative to each patch 308(1-m) of the second image 304 in an intersecting cell of the pair-wise divergence matrix 402. It should be noted that the intersecting cell is an intersection between a row associated with a patch of the header column 404 and a column associated with a patch of the header row 406.

In the pair-wise divergence matrix 402, for each of the patches of the first image 306 and each of the patches of the second image 308, a minimum pair-wise-divergence value is identified from a plurality of pair-wise divergence values determined. The minimum pair-wise divergence value represents the greater similarity between the two patches.

In an embodiment, a similarity score is calculated for the first image 302 and the second image 304 based on the pair-wise divergence matrix 402. The similarity score is calculated based on the calculation of a first weighted mean and a second weighted mean. The first weighted mean is calculated based on the minimum computed pair-wise divergence values for each of the patches 308(1-m) of the second image 304, based on the determination of the minimum pair-wise divergence value for a particular patch in a corresponding row, for each of the patches 308(1-m). It should be noted that the minimum pair-wise divergence value indicates a maximum similarity between two patches.

The first weighted mean and the second weighted mean are calculated by performing a plurality of mathematical steps. The steps may include multiplying the assigned weight to each of the patches 306(1-n) of the first image 302 by the determined minimum pair-wise divergence value of the particular patch. Further, a weighted mean of the assigned weights and the minimum pair-wise divergence value is calculated.

For example, as shown in FIG. 4A, the minimum pair-wise divergence values for each of the patches 308(1-m) are highlighted in the corresponding row. For example, the minimum divergence value for the path 308-1 is 0.11 and the minimum pair-wise divergence value for the patch 308-2 is 0.20. Similarly, for the other patches 308(1-m), the minimum pair-wise divergence value is highlighted in the pair-wise divergence matrix 402.

Similarly, the second weighted mean is calculated based on the minimum computed pair-wise divergence values for each of the patches 306(1-n) of the first image 302, based on the determination of the minimum pair-wise divergence value for a particular patch in a corresponding column, for each of the patches 306(1-n). The second weighted mean is calculated by performing a plurality of mathematical steps. The steps may include multiplying the assigned weight to each of the patches 306(1-n) of the first image 302 and each of the patches 306(1-n) of the first image 302 by the determined minimum pair-wise divergence value of the particular patch.

For example, as shown in FIG. 4B, the minimum pair-wise divergence values for each of the patches 306(1-n) are highlighted in the corresponding column. For example, the minimum divergence value for the patch 306-1 is 0.20, and the minimum pair-wise divergence value for the patch 308-2 is 0.10. Similarly, for the other patches 306(1-n) the minimum pair-wise divergence value is highlighted in the pair-wise divergence matrix 402.

In conclusion, a similarity score is calculated based on the calculated first weighted mean and the second weighted mean. In some embodiments, the similarity score may be calculated using a harmonic mean of the first weighted mean and the second weighted mean. The similarity score is computed using equation 7 given below:

$$the similarity score = \frac{2 * first weighted mean * second weight mean}{first weighted mean + second weighted mean} \qquad ( 4 )$$

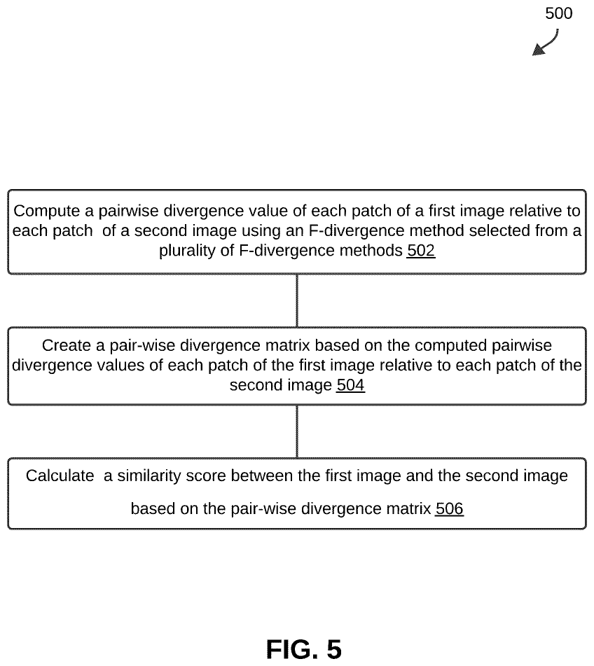

Referring now to FIG. 5, a flowchart 500 of a method for determining similarity between images using a pair-wise divergence matrix 402 is illustrated, in accordance with an exemplary embodiment of the present disclosure. In an embodiment, the method may include a plurality of steps. Each step of the flowchart 500 may be executed by various modules in the computing device 102, so as to determine the similarity between images using the pair-wise divergence matrix 402.

At step 502, a pair-wise divergence value of each patch of the first image 302 relative to each patch of the second image 304 is computed using an F-divergence method. The F-divergence method is selected from a plurality of F-divergence methods based on the computed pair-wise divergence values of each patch of the first image relative to each patch of the second image 304, a pair-wise divergence matrix 402 is created at step 504. Furthermore, the method calculates a similarity score between the first image 302 and the second image 304 based on the pair-wise divergence matrix 402 at step 506. This has already been explained in detail in conjunction with FIG. 2, FIG. 3, and FIGS. 4A-4B.

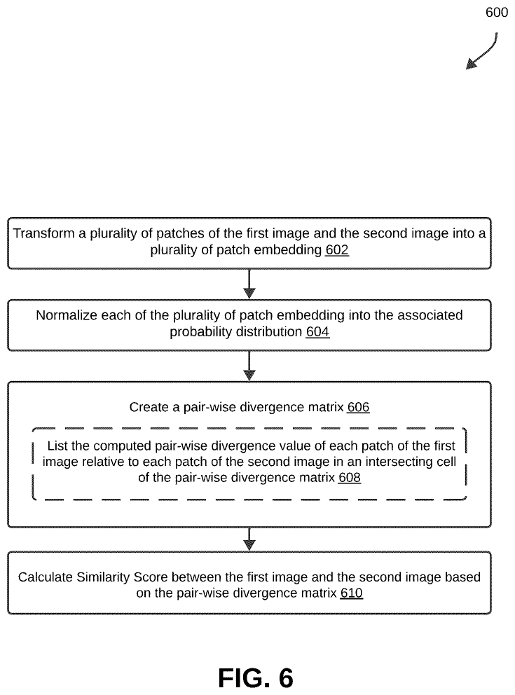

Referring now to FIG. 6, another flowchart 600 of a method for determining similarity between images using a pair-wise divergence matrix is illustrated, in accordance with an exemplary embodiment of the present disclosure. In an embodiment, the method may include a plurality of steps. Each step of the flowchart 600 may be executed by various modules in the computing device 102, so as to determine the similarity between images using a pair-wise divergence matrix 402.

In an embodiment, in the flowchart 600, a plurality of patches 306(1-n), 308(1-m) of the first image 302 and the second image 304 may be transformed into a plurality of patch embedding at step 602. Further, at step 604, each of the plurality of patch embeddings may be normalized into the associated probability distributions. At step 606, the pair-wise divergence matrix 402 may be created. Creating the pair-wise-divergence matrix 402 may include listing the computed pair-wise divergence value of each patch 306(1-n) of the first image 302 relative to each patch 308(1-m) of the second image 304 in an intersecting cell of the pair-wise divergence matrix 402 at step 608. Thereafter, at step 610, the similarity score between the first image 302 and the second image 304 may be calculated based on the pair-wise divergence matrix 402.

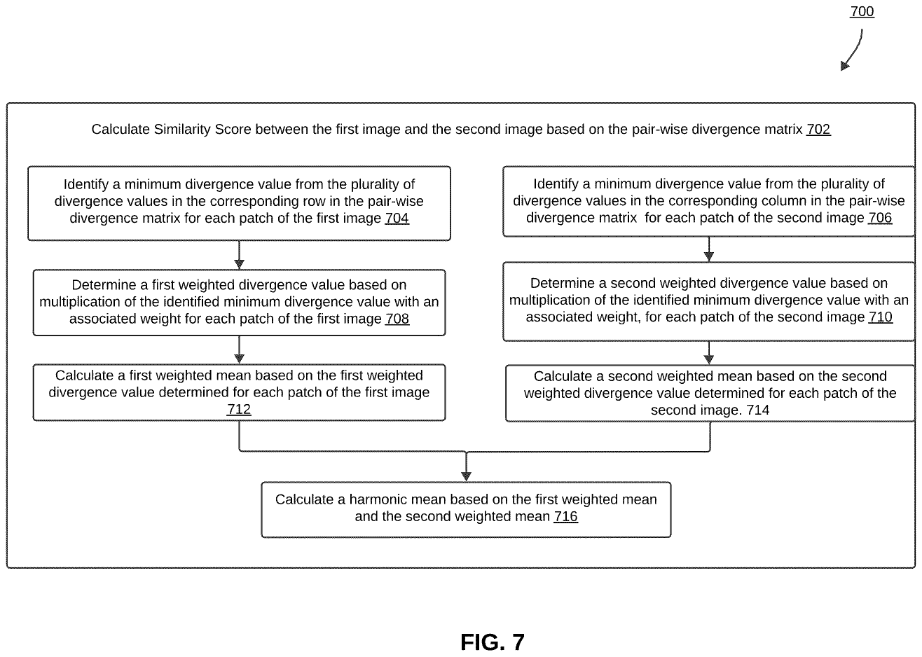

Referring now to FIG. 7, a flowchart 700 of a method for calculating similarity score is illustrated, in accordance with an exemplary embodiment of the present disclosure. In an embodiment, the method may include a plurality of steps. Each step of the flowchart 700 may be executed by various modules in the computing device 102, so as to determine the similarity between the first image 302 and the second image 304 using a pair-wise divergence matrix 402.

In an embodiment, the method may include calculating the similarity score between the first image 302 and the second image 304 based on the pair-wise divergence matrix 402 at step 702. The step 702 may include two separate processes that may be executed in parallel or consecutively by way of steps 704-714. In the first process, the step 702 may include identifying, for each patch of the first image 302, a minimum divergence value from the plurality of F-divergence values in the corresponding row in the pair-wise divergence matrix 402 at step 704.

Simultaneously, at step 706, a minimum divergence value from the plurality of F-divergence values in the corresponding column in the pair-wise divergence matrix 402 may be identified for each patch of the second image 304. At step 708 a first weighted divergence value based on the multiplication of the identified minimum divergence value with an associated weight may be determined for each patch of the first image 302. Simultaneously, at step 710, a second weighted divergence value based on the multiplication of the identified minimum divergence value with an associated weight may be determined for each patch of the second image 304.

At step 712, the first process may calculate a first weighted mean based on the first weighted divergence value determined for each patch 306(1-n) of the first image 302. Simultaneously, at step 714, the second process may calculate a second weighted mean based on the second weighted divergence value determined for each patch 308(1-n) of the second image 304. At step 716, the method may calculate a harmonic mean based on the first weighted mean and the second weighted mean, in conjunction with step 712 and step 714.

Referring now to FIG. 8, a flow diagram 800 of a method for selecting an F-divergence method from the plurality of the F-divergence methods is illustrated, in accordance with an exemplary embodiment of the present disclosure. In an embodiment, the method may include a plurality of steps. Each step of the flowchart 700 may be executed by various modules in the computing device 102, so as to determine the similarity between images using the pair-wise divergence matrix 402.

It should be noted that the selected F-divergence method is from the plurality of the F-divergence methods and is optimal. In order to select the F-divergence method, at step 802, a counter that indicates one less than the current iteration is initiated at ‘0’. At step 804, a variable ‘N’ is assigned a value that is equal to the total number of total F-divergence methods. (For example, if the total number of F-divergence methods is 5, then N=5).

At step 806, an F-divergence method is selected from the plurality of the F-divergence methods, based on a current value of a counter. Once an F-divergence method is selected, the method may determine a plurality of pair-wise divergence values for the first image 302 and the second image 304 using the selected F-divergence method at step 808. The pair-wise divergence values are determined based on creating the pair-wise divergence matrix 402. The method may compare the plurality of determined pair-wise divergence values with divergence values determined by a user for the first image 302 and the second image 304 at step 810.

In conclusion of step 810, a relevancy index for the F-divergence method is computed based on a result of the comparison in step 812. The relevancy index indicates the similarity of closeness of an F-divergence method to the actual results determined by the user. The relevancy index may be calculated for each of the F-divergence methods from the plurality of the F-divergence methods, using a predefined function such as but not limited to Spearman correlation, Pearson correlation, and the like. Each time an iteration completes the counter value is incrementing by 1, at step 814.

At step 816, a check is performed to confirm if the counter value is greater than 0 and equal to ‘N’ representing a total number of F-divergence methods, at step 816. If the counter value is equal to 0, the control moves back to step 806. If the decision value is ‘No’ at step 816, the iteration goes to step 806, and the further steps from step 806 to 812 are performed with another selected F-divergence method. However, if the counter value is greater than 0 and equal to ‘N’ the iteration terminates, and the best optimal F-divergence method is finally selected from the plurality of F-divergence methods at step 818. It should be noted that the final selected F-divergence method has the highest relevancy index. The final selected F-divergence may further be used to perform similarity determination between two images, in order to determine the optimized similarity between the first and second image.

Thus, the disclosed method for determining similarity between images is better than the existing solutions for the determination of image similarity. The disclosed method not only checks the similarity between images optimally but also works better in case of the presence of noise such as unnecessary pixels, different hues, or the presence of extra content. It should be also noted that the disclosed method not only checks the similarity between the images specifically for pixels but also semantically. Hence, the disclosed method for checking the similarity between images is better than the existing solutions. We will be discussing the advantages of the disclosed method by way of some examples in more detail hereinafter.

By way of an example, a comparison of the disclosed method with the currently existing method to determine similarity between images is demonstrated. Currently, the most used method to compare the similarity between two images is Structural Similarity Index measure (SSIM). However, there are a few cases where the SSIM methodology fails. So, in such cases, the pair-wise divergence matrix 402 may be used to compute the image similarity for optimal results. The comparison between the results of the pair-wise divergence matrix 402 methodology and the existing methodology SSIM is shown in Table 1. Also, it should be noted that a higher value of SSIM indicates that the similarity between the two images is higher, but the higher value of the pair-wise divergence matrix 402 indicates a lower similarity between the two images.

TABLE 1
Comparison between Pair-wise Divergence Matrix and SSIM

| | | Pair-wise | |
|---|---|---|---|
| Image 1 | Image 2 | Divergence Matrix | SSIM |
| Image of a First Cat | Image of a Second Cat | 0.0034 | 0.73 |
| Image of a Dog | Image of the Second | 0.0056 | 0.77 |
| | Cat | | |
| Image of a Dog | Image of a Pencil | 0.0055 | 0.86 |
| Image of an actor | Image of the same | 0.004 | 0.66 |
| wearing black shirt | actor in a blue shirt | | |
| and wearing goggles | without goggles | | |
| Image of an actor | Image of the sky with | 0.0068 | 0.62 |
| | clouds | | |

As shown in Table 1, for a plurality of similar images the pair-wise divergence matrix 402 is performing better than SSIM as the pair-wise divergence matrix 402 results in determining low values for similar images and higher values for dissimilar images as compared to the SSIM. The SSIM results in low values for similar images and higher values for dissimilar images as expected, indicating that the pair-wise divergence matrix 402 performs better than the SSIM and may be used to determine the optimal similarity score between two images.

In conclusion, the proposed Pair-wise divergence method demonstrates good resilience and accuracy in evaluating image similarity, particularly in noisy environments and rearrangement of patches, where traditional metrics like cosine similarity fail. Pair-wise divergence uses patch embedding comparisons to better capture semantic relationships and closely match human judgment.

The experimental results validate the robustness of the metric, showing a higher comparable correlation with human-annotated similarity scores than cosine similarity and other F-divergence methods. Additionally, the ability of the Pair-wise divergence method to maintain accuracy in challenging cases highlights its potential to outperform traditional approaches in real-world applications.

This invention not only sets a foundation for improved image data analysis but also opens doors for developing advanced tools in areas such as natural language understanding, recommendation systems, and content analysis. Its ability to handle noisy data with minimal preprocessing makes the Pair-wise divergence a valuable contribution to the domain of semantic similarity measurement.

Thus, the disclosed method and system try to overcome the technical problem of determining similarity between two images. In an embodiment, advantages of the disclosed method and system may include but are not limited to measuring the similarity between images that perform better than the existing matrix under noise, selecting the most relevant subject line, providing a foundation for developing new tools and applications in industries reliant on texture data analysis. The disclosed method and system significantly reduce the manual effort required by automating and determining the similarity between two or more images.

As will be appreciated by those skilled in the art, the techniques described in the various embodiments discussed above are not routine, conventional, or well-understood in the art. The techniques discussed above provide for determining the similarity between images using a pair-wise divergence matrix 402.

In light of the above-mentioned advantages and the technical advancements provided by the disclosed method and system, the claimed steps as discussed above are not routine, conventional, or well understood in the art, as the claimed steps enable the following solutions to the existing problems in conventional technologies. Further, the claimed steps bring an improvement in the functioning of the device itself as the claimed steps provide a technical solution to a technical problem.

The specification has described a method and system for determining similarity between images using a pair-wise divergence matrix. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor to perform steps or stages consistent with the embodiments described herein. The term “computer-readable medium” should be understood to include tangible items and exclude carrier waves and transient signals, i.e., non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered exemplary only, with a true scope of disclosed embodiments being indicated by the following claims.

What is claimed is:

1. A method for determining similarity between images using a pair-wise divergence matrix, the method comprises:
computing, by a processor, a pair-wise divergence value of each patch of a first image relative to each patch of a second image using an F-divergence method selected from a plurality of F-divergence methods, wherein the pair-wise divergence value is computed using a probability distribution of each patch of the first image relative to each patch of the second image;
creating, by the processor, a pair-wise divergence matrix based on the computed pair-wise divergence values of each patch of the first image relative to each patch of the second image; and
calculating, by the processor, a similarity score between the first image and the second image based on the pair-wise divergence matrix.

2. The method of claim 1, further comprises transforming a plurality of patches of the first image and a plurality of patches of the second image into a plurality of patch embeddings.

3. The method of claim 2, further comprises normalizing each of the plurality of patch embeddings into the associated probability distributions.

4. The method of claim 1, wherein a header column of the pair-wise divergence matrix comprises each patch of the first image in a unique cell and a header row of the pair-wise divergence matrix comprises each patch of the second image in a unique cell.

5. The method of claim 4, wherein creating the pair-wise divergence matrix comprises listing the computed pair-wise divergence value of each patch of the first image relative to each patch of the second image in an intersecting cell of the pair-wise divergence matrix, wherein the intersecting cell is an intersection between a row associated with a first patch of the header column and a column associated with a second patch of the header row.

6. The method of claim 1, wherein calculating the similarity score comprises:
identifying, for each patch of the first image, a minimum divergence value from the plurality oF-divergence values in the corresponding row in the pair-wise divergence matrix;
determining, for each patch of the first image, a first weighted divergence value based on the multiplication of the identified minimum divergence value with an associated weight; and
calculating a first weighted mean based on the first weighted divergence value determined for each patch of the first image.

7. The method of claim 6, further comprises:
identifying, for each patch of the second image, a minimum divergence value from the plurality of F-divergence values in the corresponding column in the pair-wise divergence matrix;
determining, for each patch of the second image, a second weighted divergence value based on the multiplication of the identified minimum divergence value with an associated weight; and
calculating, a second weighted mean based on the second weighted divergence value determined for each patch of the second image.

8. The method of claim 7, wherein calculating the similarity score comprises calculating a harmonic mean based on the first weighted mean and the second weighted mean.

9. The method of claim 7, wherein the weight associated with each patch of the first image and the second image is determined based on at least one of a plurality of weighting techniques.

10. The method of claim 1, further comprises:
identifying the F-divergence method from the plurality of F-divergence methods, wherein identifying the F-divergence method, comprises:
iteratively performing for the plurality of F-divergence methods:
selecting an F-divergence method from the plurality of the F-divergence methods, based on a current value of a counter;
determining a plurality of pair-wise divergence values for the first image and the second image using the selected F-divergence method;
comparing the plurality of determined pair-wise divergence values with divergence values determined by a user for the first image and the second image;
computing a relevancy index for the F-divergence method based on a result of the comparison; and
incrementing the current value of the counter by one, when the current value of the counter is less than the total number of the plurality of F-divergence methods; and
selecting the F-divergence method from the plurality of F-divergence methods, wherein the selected F-divergence method has the highest relevancy index.

11. A system for determining similarity between images using a pair-wise divergence matrix, the method comprises:
a processor; and
a memory communicably coupled to the processor, wherein the memory stores processor-executable instructions, which when executed by the processor, cause the processor to:
compute a pair-wise divergence value of each patch of a first image relative to each patch of a second image using an F-divergence method selected from a plurality of F-divergence methods, wherein the pair-wise divergence value is computed using a probability distribution of each patch of the first image relative to each patch of the second image;
create a pair-wise divergence matrix based on the computed pair-wise divergence values of each patch of the first image relative to each patch of the second image; and
calculate a similarity score between the first image and the second image based on the pair-wise divergence matrix.

12. The system of claim 1, wherein the processor-executable instructions further cause the processor to:
transform a plurality of patches in the first image and a plurality of patches of the second image into a plurality of patch embeddings.

13. The system of claim 2, wherein the processor-executable instructions further cause the processor to:
normalize each of the plurality of patch embeddings into the associated probability distributions.

14. The system of claim 1, wherein a header column of the pair-wise divergence matrix comprises each patch of the first image in a unique cell and a header row of the pair-wise divergence matrix comprises each patch of the second image in a unique cell.

15. The system of claim 14, wherein creating the pair-wise divergence matrix further causes the processor to:
list the computed pair-wise divergence value of each patch of the first image relative to each patch of the second image in an intersecting cell of the pair-wise divergence matrix, wherein the intersecting cell is an intersection between a row associated with a first patch of the header column and a column associated with a second patch of the header row.

16. The system of claim 1, wherein the similarity score calculation further causes the processor to:
identify a minimum divergence value from the plurality of F-divergence values for each patch of the first image, in the corresponding row in the pair-wise divergence matrix;
determine a first weighted divergence value based on the multiplication of the identified minimum divergence value with an associated weight for each patch of the first image; and
calculate a first weighted mean based on the first weighted divergence value determined for each patch of the first image.

17. The system of claim 16, wherein the processor-executable instructions further cause the processor to:
identify for each patch of the second image, a minimum divergence value from the plurality of F-divergence values in the corresponding column in the pair-wise divergence matrix;
determine for each patch of the second image, a second weighted divergence value based on the multiplication of the identified minimum divergence value with an associated weight; and
calculate for each patch of the second image a second weighted mean based on the second weighted divergence value determined.

18. The system, of claim 17, wherein calculating the similarity score further causes the processor to calculate a harmonic mean based on the first and second weighted mean.

19. The system of claim 17, wherein the weight associated with each patch of the first image and the second image is determined based on at least one of a plurality of weighting techniques.

20. The system of claim 11, wherein the processor-executable instructions further cause the processor to:
identify the F-divergence method from the plurality of F-divergence methods, wherein identifying the F-divergence method, comprises:
iteratively perform for the plurality of F-divergence methods:
select an F-divergence method from the plurality of the F-divergence methods, based on a current value of a counter;
determine a plurality of pair-wise divergence values for the first image and the second image using the selected F-divergence method;
compare the plurality of determined pair-wise divergence values with divergence values determined by a user for the first image and the second image;
compute a relevancy index for the F-divergence method based on a result of the comparison; and
increment the current value of the counter by one, when the current value of the counter is less than the total number of the plurality of F-divergence methods; and
select the F-divergence method from the plurality of F-divergence methods, wherein the selected F-divergence method has the highest relevancy index.
